(19) United States
(12) Patent Application Publication
(10) Pub. No.: US 2013/0123961 A1
(43) Pub. Date: May 16, 2013

(54) DISC JOCKEY CONTROLLER FOR A HANDHELD COMPUTING DEVICE

(71) Applicants: Christopher Roman, Wrentham, MA (US); John A. Souppa, Ashland, MA (US)

(72) Inventors: Christopher Roman, Wrentham, MA (US); John A. Souppa, Ashland, MA (US)

(73) Assignee: NUMARK INDUSTRIES, LP, Cumberland, RI (US)

(21) Appl. No.: 13/294,344

(22) Filed: Nov. 11, 2011

(51) Int. Cl. G06F 17/00

(52) U.S. Cl. 700/94

(57) ABSTRACT

A disc jockey controller for a handheld computing device is disclosed. The controller includes a body with a top surface. A cradle is configured and arranged to hold a handheld computing device in a desired orientation. A main output configured and arranged to be electrically connected to a handheld computing device. A left platter control and a right platter control are provided on the top surface of the body. The platters are rotatable and pressable to generate control data for the handheld computing device. A DJ application running on a handheld computing device is configured and arranged to use a communication protocol to receive control data from the controller. The DJ application is further configured and arranged to use the control data to apply special effects and to manipulate the first audio source and second audio source.

### CROSS-REFERENCE TO RELATED APPLICATION

The present patent document claims priority to earlier filed U.S. Provisional Patent Application Ser. No. 61/412,297, filed on Nov. 12, 2010, the entire contents of which are incorporated herein by reference.

### BACKGROUND OF THE INVENTION

1. Field of the Invention

The present patent document relates generally to controllers for disc jockeys and more specifically to a controller configured to generate control inputs to a disc jockey application running on a handheld computing device.

2. Background of the Related Art

Handheld computing devices with touch interfaces, such as the Apple® iPad® are gaining popularity with disc jockeys (“DJ”). While musical performance applications on handheld computing devices can be very powerful and capable applications, DJ's find it difficult to create and perform using just the touch interface on the screen of the device. Accordingly, there is a perceived need in the industry to enhance touch-enabled handheld computing devices in a manner the DJs find intuitive and easy to use.

Handheld computing devices are designed to be held by the user with one hand, with the user manipulating the touch screen with the other free hand. During a performance, though, a DJ often needs both hands free to queue and play music and video. Furthermore, some DJ applications present different interface controls depending upon whether the handheld computing device is positioned in a “portrait” view or in a “landscape” view. The positioning of the handheld computing device is, therefore, imperative to using the application. However, handheld computing devices lack a stand or device to properly orient the handheld computing device. Therefore, there is a perceived need in the industry for a device to properly orient the handheld computing device for the DJ that also frees both DJ's hands for use during the DJ's performance. DJs also include active performances that can be demanding on fragile touch screens. Vigorous pressing of a start control with force could break the touch screen. An external device can be more rugged for such use. Touch screens also do not provide tactile feedback to the DJ. For instance, a touch screen lacks wheels that move and spin and buttons that can be pressed and knobs turned.

Another problem with handheld computing devices used in the DJ context is the fact that they lack the capability to listen in advance of the performance. More particularly, while DJs perform they often need to listen to music privately through headphones as well as play through speakers publicly. DJs find it desirable to listen to the music in advance to playing it through the speakers, that is, they desire to be able to prevue a portion of the performance prior to playing it live through the speakers to the audience. Accordingly, there is a need for a device or method to listen to music in advance to playing it through the speakers for the DJ performance with handheld computing devices.

### SUMMARY OF THE INVENTION

The present invention solves the problems of the prior art by providing a disc jockey controller for a handheld computing device with a number of controls for manipulating and playing audio. Additionally, the disc jockey controller includes an interface with an application executing on a handheld computing device. The disc jockey controller also includes the optional ability to position the handheld computing device in the desired orientation (such as landscape or portrait). The disc jockey controller further includes a headphone and speaker outputs to permit the DJ to listen to audio through a headphones prior to playing the audio through the speaker output.

### BRIEF DESCRIPTION OF THE DRAWINGS

These and other features, aspects, and advantages of the present invention will become better understood with reference to the following description, appended claims, and accompanying drawings where:

FIG. 1 is a front perspective view of an embodiment of a disc jockey controller of the present invention with a handheld computing device connected thereto in a landscape orientation;

FIG. 2 a rear view of an embodiment of the disc jockey controller of the present invention;

FIG. 3 is a diagram of the operation of an embodiment of a disc jockey controller of the present invention; and

FIG. 4 is a front perspective view of an alternate embodiment of a disc jockey controller of the present invention with a handheld computing device connected thereto in a portrait orientation.

### DESCRIPTION OF THE PREFERRED EMBODIMENT

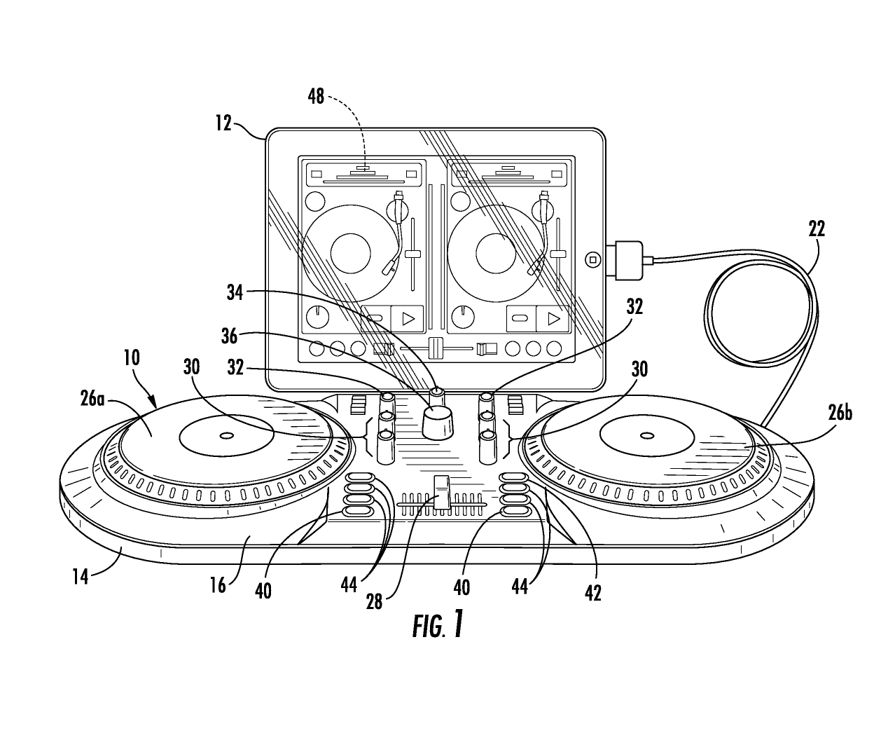

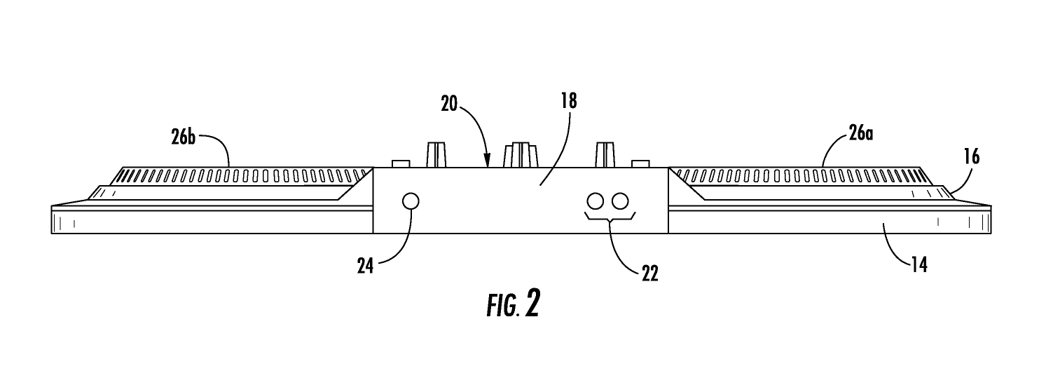

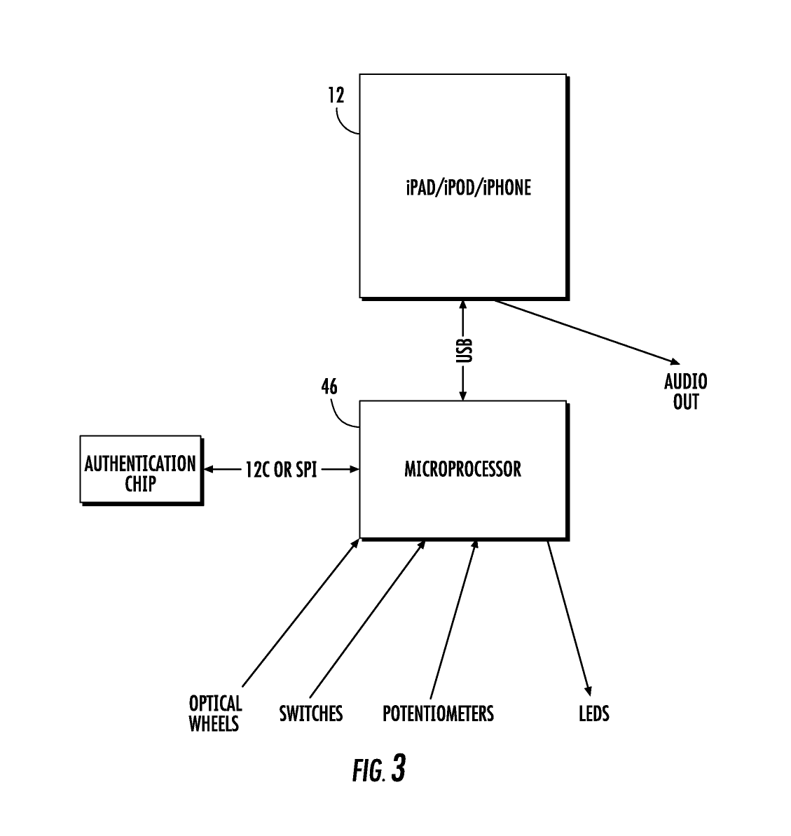

Referring now to FIGS. 1-3, a disc jockey controller for a handheld computing device of the present invention is shown generally at 10. The controller 10 includes a control surface 12 with a number of typical DJ controls such as, but not limited to, touch sensitive wheels (or platters), knobs, buttons, LEDs, line faders, and a crossfader. The controller 10 further includes a cradle (or dock) configured to hold a handheld computing device 12 therein in the desired orientation, i.e. portrait or landscape.

More specifically, the controller 10 includes a body 14 with a top surface 16 and rear panel 18. Extending from the rear panel 18 is a cradle 20 configured to hold a handheld computing device 12 therein in the desired orientation. The cradle 20 may have a connector integrated therein to connect to the dock, or a separate cable 22 extending from the rear panel 18 may be provided as shown in FIG. 1.

A main output 22 is provided on the rear panel. A phono output 24 for headphone is also provided. Additional audio outputs may be provided to provide separate stereo channels or different types of connectors such as RCA jacks and XLR connectors. Additionally, the built-in audio output of the handheld computing 12 device may be used.

A left platter control 26a and a right platter control 26b are provided on the top surface 16 of the controller 10. Both platters 26a,26b are rotatable and may optionally be pressed. Rotating or touching either platter 26a,26b generates control data that is transmitted or read by the handheld computing device 12.

Also included is a cross fader control 28 configured to also generate control data that is transmitted or read by the handheld computing device 12 fade from a first audio source to a second audio source.

Equalizer controls 30 may also be provided to adjust bass, midrange and treble of each audio source. An optional gain control and volume control 32 may also be provided for each audio source, including a master volume control 34. Each control provides control data that may be transmitted to or read by the handheld computing device.

Further included may be a select knob 36 configured to generate control data used to navigate menus and select items on the DJ application running on the handheld computing device 12 if the touch screen on the handheld computing device 12 is not used.

Also, various play 40, beat-matching 42 and cue controls 44 may be provided to control the timing and sequence between the first audio source and the second audio source.

The controller 10 is configured to communicate with a DJ application 48 executing on a handheld computing device 12 through the connector, cable 22 or a wireless adapter. The communication protocol used permits the transmission of control data and settings data to a DJ application 48 running on the handheld computing device 12. The communication protocol could be a standard protocol such as MIDI, Bluetooth, HID, or could be a proprietary protocol. The controller 10 may be configured to send control data and settings data to the handheld computing device 12, or the DJ application 48 may be configured to query the handheld computing device 12 to read from the controller 10 itself Preferably, the controller 10, includes a microprocessor 46 that detects a user's interactions with the various controls on the control surface 16, converts the interactions into control data and transmits the control data to the handheld computing device 12. Alternatively, or permits the handheld computing device to query the inputs)

The controller 10 may be configured to be powered by the internal power supply of the handheld computing device 12. Alternatively, the controller 10 may be configured to supply power to the handheld computing device 12.

In addition to a cradle 20, the controller 10 may be connected to the handheld computing device 20 via a cable 22. Alternatively, the controller 10 may be further configured to communicate with the handheld computing 10 wirelessly through a standard protocol such as Bluetooth.

The first audio and second audio sources from the handheld computing device 12 may be split and mixed for phono output and the master output 22 on the controller 10. The controller 10 may be capable to transmit one or two stereo channels that comprise the first audio and second audio sources. In the instance where the controller 10 is configured to route a single stereo audio channel, the controller 10 routes right and left audio as same source stereo to main output 22 and the phono output 24. If the controller 10 is configured to route two stereo audio channels, the controller 10 may route separate stereo audio to the main output 22 and the phono output 24, respectively. In this manner, a DJ may preview audio through the phono 24 output prior to playing the audio through the main output 22. Alternatively, the controller 10 may output audio through the built-in audio output of the handheld computer device 12. Furthermore, the main output 22 may be capable of splitting stereo audio into two separate mono outputs and allowing cue on one channel, while master audio is on the other.

The DJ application 48 running on the handheld computing device 12 uses control data generated from the controls and buttons of the controller 10 to apply special effects and to manipulate the first audio source and second audio source. For instance, manipulation of the first platter and/or second platter 26a,26b may be configured to apply a scratch effect to the first audio source and second audio source, respectively. Also, the DJ application 48 will read setting data and control data from the controller 10 in order to beat match and cue the first audio source and second audio source. Furthermore, the inclusion of both a phono output 24 and main output 22 permits the controller 10 to route audio in a manner to permit the DJ to listen to music in advance to playing it through external speakers (not shown).

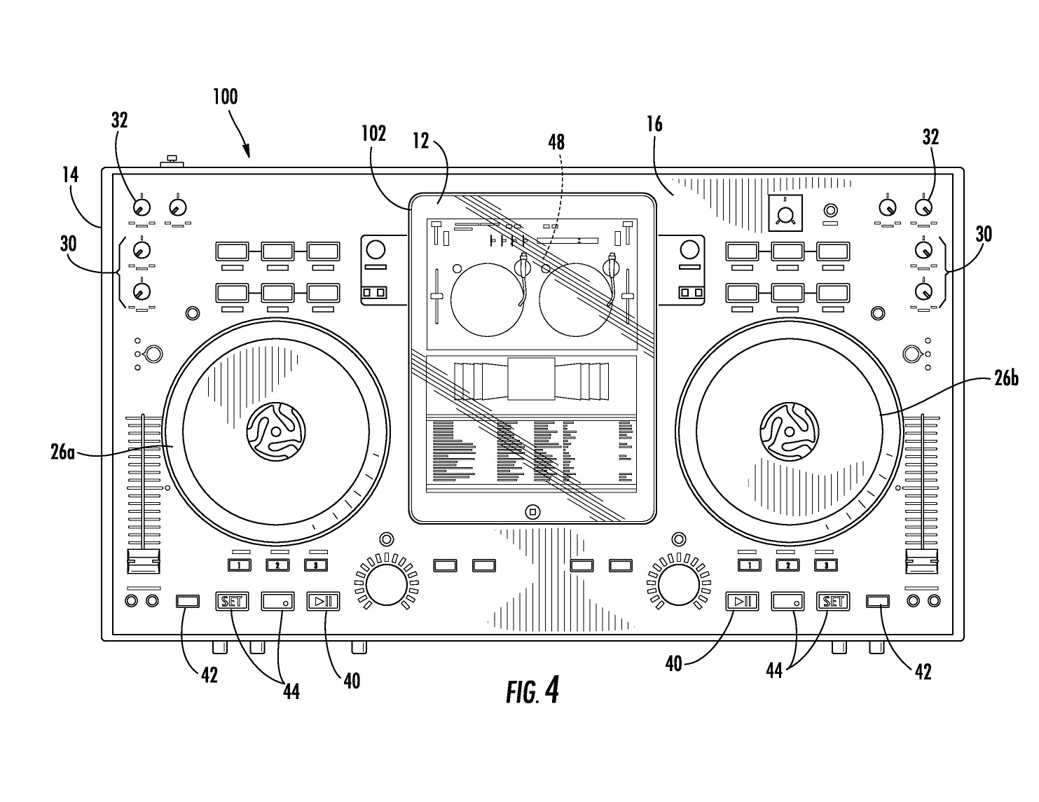

Referring to FIG. 4, an alternative embodiment of the disc jockey controller for a handheld computing device is shown generally at 100. The primary difference of the alternative embodiment 100 is that the handheld computing device 12 is docked in a portrait orientation in a recess 102 formed on the control surface 16 of the controller 100. In all other respects, the alternative embodiment 100 may include all the same features as the first embodiment 10 described above.

Therefore, it can be seen that the present invention provides a unique solution to the problem of providing a controller 10 for a handheld computing device 12 that allows a DJ to use both hands and properly orients the handheld computing device 12 for the DJ during the DJ's performance.

It would be appreciated by those skilled in the art that various changes and modifications can be made to the illustrated embodiments without departing from the spirit of the present invention. All such modifications and changes are intended to be within the scope of the present invention.

What is claimed is:

1. A disc jockey controller for a handheld computing device, comprising:
a body with a top surface;
a cradle configured and arranged to hold a handheld computing device in a desired orientation;
a main output configured and arranged to be electrically connected to the handheld computing device;
a left platter control and a right platter control are provided on the top surface of the body; said platters are rotatable and pressable to generate control data; and
a DJ application configured and arranged to run on a handheld computing device; said DJ application further configured and arranged to use a communication protocol to receive control data, the DJ application further configured and arranged to use the control data to apply special effects and to manipulate the first audio source and second audio source.

2. The disc jockey controller of claim 1, further comprising a cross fader control configured and arranged to generate control data for the DJ application to fade from the first audio source to and from the second audio source.

3. The disc jockey controller of claim 1, further comprising equalizer controls to generate control data for the DJ applications to adjust bass, midrange and treble of each audio source.

4. The disc jockey controller of claim 1, further comprising a gain control and volume control to adjust the gain and volume of the main output.

5. The disc jockey controller of claim 1, further comprising a select knob configured to generate control data for the DJ application to navigate menus and select items thereon.

6. The disc jockey controller of claim 1, further comprising beat-matching controls to generate control data for the DJ application to synchronize the beats of the first audio source and the second audio source.

7. The disc jockey controller of claim 1, further comprising cue controls to generate control data for the DJ application to sequence the first audio source and the second audio source.

8. The disc jockey controller of claim 1, further comprising separate stereo channels in the main output.

9. The disc jockey controller of claim 1, wherein the DJ application is further configured and arranged to read control data and settings data from the disc jockey controller.

10. The disc jockey controller of claim 1, further comprising a phono output for headphones.

11. The disc jockey controller of claim 10, wherein the first audio source and the second audio source may be selectively routed between the main output and the phono output.

12. The disc jockey controller of claim 1, wherein the cradle is configured and arranged to support a handheld computing device in a portrait orientation.

13. The disc jockey controller of claim 1, wherein the cradle is configured and arranged to support a handheld computing device in a landscape orientation.
